(19) United States
(12) Patent Application Publication
(10) Pub. No.: US 2017/0134383 A1
(43) Pub. Date: May 11, 2017

(54) METHOD AND DEVICE FOR SHARING A RESOURCE

(71) Applicants: Le Holdings(Beijing)Co., Ltd., Beijing (CN); LEMOBILE INFORMATION TECHNOLOGY (BEIJING) CO., LTD, Beijing (CN)

(72) Inventor: Huijie Wu, Beijing (CN)

(21) Appl. No.: 15/222,902

(22) Filed: Jul. 28, 2016

Related U.S. Application Data
(63) Continuation of application No. PCT/CN2016/082915, filed on May 20, 2016.

(30) Foreign Application Priority Data
Nov. 6, 2015 (CN) 201510758259.7

(51) Int. Cl. H04L 29/06; H04W 48/16; H04W 12/06; H04W 12/08

(52) U.S. Cl. CPC H04L 63/10; H04W 12/08; H04W 48/16; H04L 63/062; H04L 63/083; H04W 12/06; H04W 84/12

(57) ABSTRACT

The invention provides a method for accessing a resource, the method including: receiving, by a sharing device, request information transmitted by an accessing device; and transmitting, by the sharing device, response information carrying an access password to the accessing device in response to the request information so that the accessing device can access using the access password, and shares a resource associated with the sharing device. The invention dispenses with the step of entering the password manually during the access to thereby obviate the manual operation so as to avoid the unnecessary trouble of entering the password manually, thus making the access easier and more convenient, and also avoid network traffic from being misused because a user simplifies the password which would otherwise be troublesome to enter.

This application is a continuation of International Application No. PCT/CN2016/082915, filed on May 20, 2016, designating the United States, and claiming the benefit of Chinese Patent Application No. 201510758259.7, filed with the Chinese Patent Office on Nov. 6, 2015 and entitled “Method and device for sharing a resource”, which is hereby incorporated by reference in its entirety.

### TECHNICAL FIELD

The present invention relates to the field of network control, and particularly to a method and device for sharing a resource.

### BACKGROUND

Wireless Fidelity (WIFI) which is a wireless connection technology currently has become more and more important to smart phones. However a smart phone has to access a new WIFI service each time the smart phone is carried into a new environment, and a WIFI password currently has become more and more complex, so it may be troublesome to enter the WIFI password manually.

In the prior art, the WIFI service is accessed by a user picking out a Service Set Identifier (SSID) of the service to be accessed, from a list of Access Points (APs) located by the smart phone, and entering the password for an access.

Since the WIFI password is generally complex at present in that it may include digits, uppercase and lowercase letters, special characters, etc., e.g., jgjgjgggGJ, #iG86a¥%)mW, aUQI0o0OiOYiQwejuAJLI, etc., such a password may be difficult to pronounce, or may include a variety of characters making the password so long that it may be difficult for the user to access the WIFI service; and some user may simplify the WIFI password for himself or herself to enter it conveniently, and consequently may have his or her WIFI password cracked and network traffic misused.

### SUMMARY

Embodiments of the invention provide a method and device for sharing a resource, where a sharing device transmits response information carrying an access password to an accessing device in response to request information transmitted by the accessing device so that the accessing device accesses using the access password, and further can share a resource associated with the sharing device; and the invention dispenses with the step of entering the password during the access to thereby obviate the manual operation so as to avoid the unnecessary trouble of entering the password manually, thus making the access easier and more convenient, and also avoid network traffic from being misused because the user simplifies the password which would otherwise be troublesome to enter.

An embodiment of the invention provides a method for sharing a resource, the method including:
receiving, by a sharing device, request information transmitted by an accessing device; and
transmitting, by the sharing device, response information carrying an access password to the accessing device according to the request information so that the accessing device accesses using the access password, and shares a resource associated with the sharing device.

An embodiment of the invention provides a sharing device including:
a receiving module configured to receive request information transmitted by an accessing device; and
a transmitting module configured to transmit response information carrying an access password to the accessing device according to the request information so that the accessing device accesses using the access password, and shares a resource associated with the sharing device.

An embodiment of the invention provides a method for sharing a resource, the method including:
transmitting, by an accessing device, request information;
receiving, by the accessing device, response information carrying an access password returned by a sharing device in response to the request information; and
accessing, by the accessing device, using the access password so that the accessing device shares a resource associated with the sharing device.

An embodiment of the invention provides an accessing device including:
a transmitting module configured to transmit request information;
a receiving module configured to receive response information carrying an access password returned by a sharing device in response to the request information; and
an accessing module configured to access using the access password so that the accessing device shares a resource associated with the sharing device.

In the embodiments of the invention, the sharing device transmits the response information carrying the access password to the accessing device in response to the request information transmitted by the accessing device so that the accessing device can access using the access password, and further can share a resource associated with the sharing device; and the invention dispenses with the step of entering the password manually during the access to thereby obviate the manual operation so as to avoid the unnecessary trouble of entering the password manually, thus making the access easier and more convenient, and also avoid network traffic from being misused because the user simplifies the password which would otherwise be troublesome to enter.

### BRIEF DESCRIPTION OF THE DRAWINGS

In order to make the technical solutions according to the embodiments of the invention or in the prior art more apparent, the drawings to which a description of the embodiments or the prior art refers will be briefly introduced below, and apparently the drawings to be described below are merely illustrative of some of the embodiments of the invention, and those ordinarily skilled in the art can derive from these drawings other drawings without any inventive effort. In the drawings:

FIG. 1 is a first flow chart of a method for sharing a resource according to an embodiment of the invention;

FIG. 2 is a second flow chart of a method for sharing a resource according to an embodiment of the invention;

FIG. 3 is a schematic structural diagram of a sharing device according to an embodiment of the invention; and

FIG. 4 is a schematic structural diagram of an accessing device according to an embodiment of the invention.

### DESCRIPTION OF THE EMBODIMENTS

In order to make the objects, technical solutions, and advantages of the embodiments of the invention more apparent, the technical solutions according to the embodiments of the invention will be described below clearly and fully with reference to the drawings in the embodiments of the invention, and apparently the embodiments described below are only a part but not all of the embodiments of the invention. Based upon the embodiments here of the invention, all the other embodiments which can occur to those skilled in the art without any inventive effort shall fall into the scope of the invention.

As illustrated in FIG. 1 showing a first flow chart of a method for sharing a resource according to an embodiment of the invention, the method can include the following steps:

In the step 101, a sharing device receives request information transmitted by an accessing device.

The request information includes the name of the accessing device, and an access request.

Particularly the request information transmitted by the accessing device can be transmitted in light, in a wave, electrically, in a short message, or over another carrier capable of carrying information, e.g., a ultrasonic wave, a short message of a mobile phone, infrared, Bluetooth, or an application capable of instant communication, and the invention is intended to transmit the request information, so any transmission scheme for this intension shall fall into the scope of the invention as claimed.

In the step 102, the sharing device transmits response information carrying an access password to the accessing device according to the request information so that the accessing device accesses using the access password, and shares a resource associated with the sharing device.

The sharing device transmits the response information carrying the access password to the accessing device according to the request information particularly as follows:

The sharing device transmits first response information carrying the name of the accessing device, and a key to the accessing device according to the access request information, and the name of the accessing device;

The sharing device receives verification information carrying the name of the accessing device, and the key returned by the accessing device in response to the first response information;

The sharing device determines whether the name of the accessing device corresponds to the key; and

If so, then the sharing device transmits second response information carrying an access password to the accessing device.

Particularly after the sharing device receives the request information, in order to guarantee the security and accuracy of the information, the sharing device needs to perform a handshake procedure, i.e., a verification procedure, with the accessing device, so that the accessing device corresponds to the key in a one-to-one manner.

Upon reception of the request information, the sharing device generates the corresponding first response information according to the access request in the request information, and then adds the name of the accessing device in the request information to the first response information, and transmits the first response information to the accessing device; and upon reception of the first response information, the accessing device transmits the verification information carrying the name of the accessing device, and the key to the sharing device so that the sharing device determines whether the name of the accessing device corresponds, and if so, which indicates that the sharing device shakes hands with the accessing device successfully, then the sharing device can transmit the second response information carrying the access password to the accessing device, so that the accessing device accesses using the access password, and shares a resource associated with the sharing device; otherwise, which indicates that the sharing device shakes hands with the accessing device unsuccessfully, then the sharing device will not transmit the access password to the accessing device, so that the accessing device will not share a resource associated with the sharing device.

Before the sharing device determines whether the name of the accessing device corresponds to the key, the method further includes:

The sharing device determines whether the time lag between the time when the first response information is transmitted, and the time when the verification information is received is above a threshold; and

If not, then the sharing device will determine that the name of the accessing device corresponds to the key.

Particularly if the accessing device transmits before the access in the same mode as that after the access, then it will be determined whether the current network is stable or good, so upon reception of the verification information transmitted by the accessing device, the sharing device determines whether the time lag between the time when the first response information is transmitted, and the time when the verification information is received is above the threshold, and particularly determines the first response information and the verification information to be compared, according to the name of the accessing device, and then determines whether the time lag is above the threshold after the corresponding first response information and verification information is determined, and if so, then it will indicate that the current network is not stable, or the current network environment is not good, so it is not advisable to access at this time, and consequently the sharing device will neither further determine whether the name of the accessing device corresponds to the verification information nor transmit the access password; otherwise, it will indicate that the current network is normal, and the sharing device will further determine whether the name of the accessing device, and the key in the verification information correspond to each other.

The accessing device accessing using the access password can access the sharing device, or can access another device associated with the sharing device.

A resource associated with the sharing device can be shared particularly as follows: if the sharing device shares its own resource, then the accessing device will access the sharing device, for example, if the sharing device is a mobile phone which sets itself to a hotspot, then the accessing device will access the mobile phone, and then can share traffic of the mobile phone; and if the mobile phone sets its own data information as a shared resource, then the accessing device will access the mobile phone, and then can view the data information shared in the mobile phone. Of course, the sharing device can alternatively be another device, e.g., a computer, a tablet computer, or any one of various servers capable of providing resources or services. If the sharing device shares a resource accessed by the sharing device, then the accessing device will access a resource device accessed by the sharing device, for example, if the sharing device is a mobile phone A, and the resource device is a WIFI device, then if the mobile phone A currently has accessed the WIFI device, then if the accessing device is a mobile phone B, then the mobile phone B will access the WIFI device, where the accessing device can alternatively be another device, e.g., a computer, a tablet computer, etc., and the resource device can be any one of various devices capable of providing resources or services.

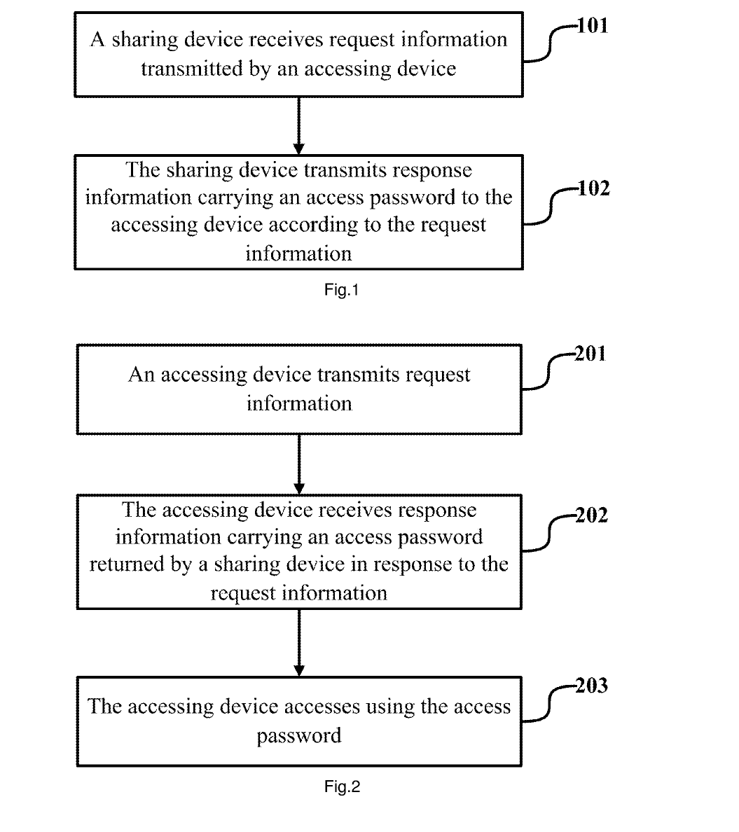

As illustrated in FIG. 2 showing a schematic flow chart of a method for sharing a resource according to an embodiment of the invention, the method can include the following steps:

In the step 201, an accessing device transmits request information.

The request information includes the name of the accessing device, and an access request.

In the step 202, the accessing device receives response information carrying an access password returned by a sharing device in response to the request information.

The accessing device receives the response information carrying the access password returned by the sharing device in response to the request information particularly as follows:

The accessing device receives first response information carrying a key returned by the sharing device in response to the access request and the name of the access device;

The accessing device transmits verification information carrying the key, and the name of the accessing device to the sharing device according to the key; and

The accessing device receives second response information carrying the access password returned by the sharing device in response to the key and the name of the access device.

A detailed process thereof has been detailed above, so a repeated description thereof will be omitted here.

Before the accessing device transmits the verification information carrying the key, and the name of the accessing device to the sharing device, the method further includes:

The accessing device determines whether the time lag between the time when the request information is transmitted, and the time when the first response information is received is above a threshold; and

If not, then the accessing device will determine whether the first response message is transmitted thereto, according to the name of the accessing device carried in the first response information;

If so, the accessing device transmits the verification information carrying the key, and the name of the accessing device to the sharing device.

Particularly if the accessing device transmits before the access in the same mode as that after the access, then the accessing device will also determine whether the current network environment is stable or good, so upon reception of the first response information, the accessing device determines whether the time lag between the time when the request information is transmitted, and the time when the first response information is received is above the threshold, and if so, then it will indicate that the current network environment is not stable, or the current network environment is not good, so it is not advisable to access at this time; otherwise, it will indicate that the current network environment is stable, or the current network environment is good, and the accessing device will determine whether the first response information is transmitted thereto, particularly according to the name of the accessing device in the first response information, and if so, it will indicate that the first response information is returned in response to the request information transmitted by the accessing device, and the accessing device will transmit the verification information carrying the key, and the name of the accessing device to the sharing device to thereby perform a handshake procedure; otherwise, it will indicate that the first response information is intended for another accessing device, but transmitted in error due to some reason, and at this time, the accessing device will delete the first response information, and further wait for first response information corresponding to the request information transmitted by the accessing device.

In the step 203, the accessing device accesses using the access password so that the accessing device shares a resource associated with the sharing device.

In the embodiment of the invention, the sharing device transmits the response information carrying the access password to the accessing device in response to the request information transmitted by the accessing device so that the accessing device can access using the access password, and further can share a resource associated with the sharing device; and the invention dispenses with the step of entering the password manually during the access to thereby obviate the manual operation so as to avoid the unnecessary trouble of entering the password manually, thus making the access easier and more convenient, and also avoid network traffic from being misused because the user simplifies the password which would otherwise be troublesome to enter.

In order to further set forth the technical idea of the invention, the technical solution according to the invention will be described hereinafter in connection with a particular application scenario, and particularly by way of an example in which the sharing device is a mobile phone A, and the accessing device is a mobile phone B; and the mobile phone A needs to share with the mobile phone B a password of a WIFI device accessed by the mobile phone A so that the mobile phone B can access the WIFI device, where both the mobile phone A and the mobile phone B are provided with sound wave generator, and the mobile phone A has accessed the WIFI device; and the access password of the WIFI device is 123456, and the device name of the mobile phone B is TW.

The mobile phone B transmits the TW, and a command to request for accessing the WIFI device to the mobile phone A in an ultrasonic wave at a different sound wave frequency, and upon reception of the ultrasonic wave, the mobile phone A obtains the TW and the command in the ultrasonic wave, generates response information from the command, and adds a key of 1234, and the TW to the response information; if the mobile phone B receives the response information in a preset period of time, then the mobile phone B will determine from the name in the response information whether the response information is transmitted thereto, and if so, then the mobile phone B will carry the key and the TW again in the ultrasonic wave, and transmit them to the mobile phone A for verification; and the mobile phone A will parse the ultrasonic wave, and if it is determined that the key corresponds to the TW, then the mobile phone A and the mobile phone B has performed a handshake procedure, that is, the verification has been passed, and at this time, the mobile phone A transmits the password of the WIFI device to the mobile phone B, and the B accesses the WIFI device using the WIFI password.

In order to further set forth the technical idea of the invention, the technical solution according to the invention will be described hereinafter in connection with a particular application scenario, and particularly the mobile phone A shares learning material stored therein, and sets a password, and the mobile phone B intends to browse the leaning material, where the mobile phone B transmits through Bluetooth before and after accessing the mobile phone A

The mobile phone B carries the name of the mobile phone, and an access request in access request information, and transmits them to the mobile phone A through Bluetooth, and upon reception of the access request, the mobile phone A generates corresponding response information, adds the name of the mobile phone B, and a corresponding key to the response information, and transmits the response information to the mobile phone B through Bluetooth; and upon reception of the response information, the mobile phone B determines whether the time lag between the time when the response information is received, and the time when the access request information is transmitted is above a threshold, and if so, then the mobile phone B will not access currently; otherwise, the mobile phone B will compare the name of the mobile phone carried in the response information with its own name of the mobile phone. If they are not the same, then the mobile phone B will further wait for response information transmitted by the mobile phone A, corresponding to the access request information; otherwise, the mobile phone B will carry its own name of the mobile phone, and the received key in verification information, and transmit the verification information to the mobile phone A through Bluetooth; and upon reception of the verification information, the mobile phone A will determine whether the time lag between the time when the verification information is received, and the time when the response information is transmitted is above a threshold, and if so, then the mobile phone A will end the flow; otherwise, the mobile phone A will further determine whether the name of the mobile phone, and the key carried in the verification information correspond to each other. If not, then the mobile phone A will end the flow, otherwise, the mobile phone A will transmit the preset password to the mobile phone B, and upon reception of the password, the mobile phone B will access the mobile phone A using the password, and access the learning material shared in the mobile phone A through Bluetooth.

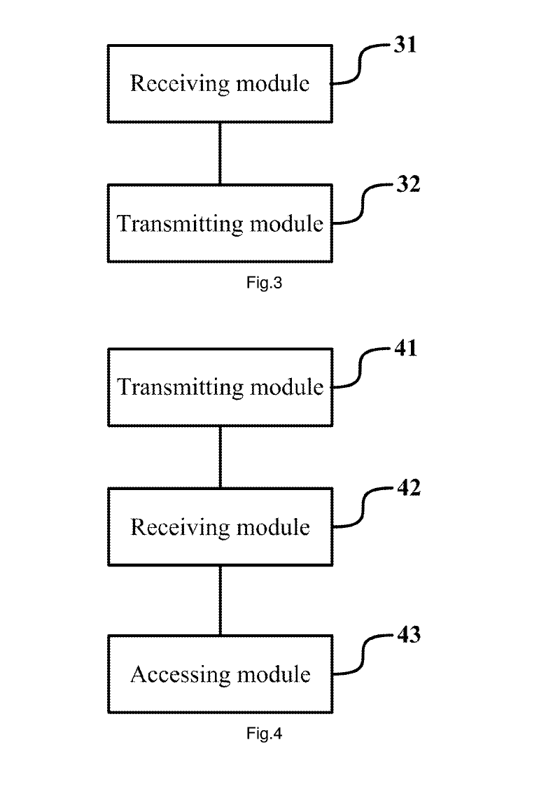

Based upon the same inventive concept as the method above, an embodiment of the invention further provides a sharing device as illustrated in FIG. 3, which includes:

A receiving module 31 is configured to receive request information transmitted by an accessing device; and

A transmitting module 32 is configured to transmit response information carrying an access password to the accessing device according to the request information so that the accessing device accesses using the access password, and shares a resource associated with the sharing device.

The request information includes:

The name of the accessing device, and an access request.

The transmitting module 32 particularly includes:

A first transmitting sub-module is configured to transmit first response information carrying the name of the accessing device, and a key to the accessing device according to the access request information and the name of the accessing device;

A receiving sub-module is configured to receive verification information carrying the name of the accessing device, and the key returned by the accessing device in response to the first response information;

A determining sub-module is configured to determine whether the name of the accessing device corresponds to the key; and

A second transmitting sub-module is configured, if so, to transmit second response information carrying an access password to the accessing device.

The device further includes:

A determining module is configured to determine whether the time lag between the time when the first response information is transmitted, and the time when the verification information is received is above a threshold; and if not, then the determining sub-module is configured to determine whether the name of the accessing device corresponds to the key.

Based upon the same inventive concept as the method above, an embodiment of the invention further provides an accessing device as illustrated in FIG. 4, which includes:

A transmitting module 41 is configured to transmit request information;

A receiving module 42 is configured to receive response information carrying an access password returned by a sharing device in response to the request information; and

An accessing module 43 is configured to access using the access password so that the accessing device shares a resource associated with the sharing device.

The request information includes:

The name of the accessing device, and an access request.

The receiving module 42 particularly includes:

A first receiving sub-module is configured to receive first response information carrying a key returned by the sharing device in response to the access request and the name of the access device;

A first transmitting sub-module is configured to transmit verification information carrying the key, and the name of the accessing device to the sharing device according to the key; and

A second receiving sub-module is configured to receive second response information carrying the access password returned by the sharing device in response to the key and the name of the access device.

The device further includes:

A first determining sub-module is configured to determine whether the time lag between the time when the request information is transmitted, and the time when the first response information is received is above a threshold; and

A second determining sub-module is configured, if not, to determine whether the first response message is transmitted to the accessing device, according to the name of the accessing device carried in the first response information; and

A second transmitting sub-module is configured, if so, to transmit the verification information carrying the key, and the name of the accessing device to the sharing device.

In the embodiments of the invention, the sharing device transmits the response information carrying the access password to the accessing device in response to the request information transmitted by the accessing device so that the accessing device can access using the access password, and further can share a resource associated with the sharing device; and the invention dispenses with the step of entering the password manually during the access to thereby obviate the manual operation so as to avoid the unnecessary trouble of entering the password manually, thus making the access easier and more convenient, and also avoid network traffic from being misused because the user simplifies the password which would otherwise be troublesome to enter.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the invention. This can be understood and practiced by those ordinarily skilled in the art without any inventive effort.

Lastly it shall be noted that the respective embodiments above are merely intended to illustrate but not to limit the technical solution of the invention; and although the invention has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the invention as claimed.

What is claimed is:

1. A method for accessing a resource, the method comprising:
receiving, by a sharing device, request information transmitted by an accessing device; and
transmitting, by the sharing device, response information carrying an access password to the accessing device according to the request information so that the accessing device accesses using the access password, and shares a resource associated with the sharing device.

2. The method according to claim 1, wherein the request information comprises:
the name of the accessing device, and an access request.

3. The method according to claim 2, wherein the transmitting, by the sharing device, the response information carrying the access password to the accessing device according to the request information comprises:
transmitting, by the sharing device, first response information carrying the name of the accessing device, and a key to the accessing device according to the access request and the name of the accessing device;
receiving, by the sharing device, verification information carrying the name of the accessing device, and the key returned by the accessing device in response to the first response information;
determining, by the sharing device, whether the name of the accessing device corresponds to the key; and
if so, then transmitting, by the sharing device, second response information carrying an access password to the accessing device.

4. The method according to claim 3, wherein before the determining, by the sharing device, whether the name of the accessing device corresponds to the key, the method further comprises:
determining, by the sharing device, whether the time lag between the time when the first response information is transmitted, and the time when the verification information is received is above a threshold; and
if not, then determining, by the sharing device, whether the name of the accessing device corresponds to the key.

5. A sharing device, comprising a processor and a memory for storing instructions executable by the processor, wherein the processor is configured to:
receive request information transmitted by an accessing device; and
transmit response information carrying an access password to the accessing device according to the request information so that the accessing device accesses using the access password, and shares a resource associated with the sharing device.

6. The device according to claim 5, wherein the request information comprises:
the name of the accessing device, and an access request.

7. The device according to claim 6, wherein the processor configured to transmit response information carrying an access password to the accessing device according to the request information is configured:
to transmit first response information carrying the name of the accessing device, and a key to the accessing device according to the access request and the name of the accessing device;
to receive verification information carrying the name of the accessing device, and the key returned by the accessing device in response to the first response information;
to determine whether the name of the accessing device corresponds to the key; and
if so, to transmit second response information carrying an access password to the accessing device.

8. The device according to claim 7, wherein the processor is further configured:
to determine whether the time lag between the time when the first response information is transmitted, and the time when the verification information is received is above a threshold; and if not, then to determine whether the name of the accessing device corresponds to the key.

9. A method for sharing a resource, the method comprising:
transmitting, by an accessing device, request information;
receiving, by the accessing device, response information carrying an access password returned by a sharing device in response to the request information; and
accessing, by the accessing device, using the access password so that the accessing device shares a resource associated with the sharing device.

10. The method according to claim 9, wherein the request information comprises:
the name of the accessing device, and an access request.

11. The method according to claim 10, wherein the receiving, by the accessing device, the response information carrying the access password returned by the sharing device in response to the request information comprises:
receiving, by the accessing device, first response information carrying a key returned by the sharing device in response to the access request and the name of the access device;
transmitting, by the accessing device, verification information carrying the key, and the name of the accessing device to the sharing device according to the key; and
receiving, by the accessing device, second response information carrying the access password returned by the sharing device in response to the key and the name of the access device.

12. The method according to claim 11, wherein before the transmitting, by the accessing device, the verification information carrying the key, and the name of the accessing device, the method further comprises:
determining, by the accessing device, whether the time lag between the time when the request information is transmitted, and the time when the first response information is received is above a threshold; and
if not, then determining, by the accessing device, whether the first response message is transmitted thereto, according to the name of the accessing device carried in the first response information; and
if so, then transmitting, by the accessing device, the verification information carrying the key, and the name of the accessing device to the sharing device.
